(19) United States
(12) Patent Application Publication
(10) Pub. No.: US 2026/0019127 A1
(43) Pub. Date: Jan. 15, 2026

(54) COHERENT JOINT TRANSMISSION CHANNEL STATE INFORMATION FEEDBACK REPORTING FOR MULTIPLE TRANSMIT RECEIVE POINTS

(71) Applicant: QUALCOMM Incorporated, San Diego, CA (US)

(72) Inventors: Chao WEI, Beijing (CN); Jing DAI, Beijing (CN); Min HUANG, Beijing (CN)

(21) Appl. No.: 19/113,727

(22) PCT Filed: Nov. 9, 2022
(86) PCT No.: PCT/CN2022/130769

§ 371 Date: Mar. 20, 2025

(51) Int. Cl. H04B 7/06; H04W 72/044

(52) U.S. Cl. CPC H04B 7/0626; H04W 72/044

(57) ABSTRACT

Various aspects of the present disclosure generally relate to wireless communication. In some aspects, a user equipment (UE) may receive one or more reference signals from multiple transmit receive points (TRPs) associated with a network node. The UE may transmit, to the network node and based at least in part on the one or more reference signals, a coherent joint transmission (CJT) Type II channel state information (CSI) feedback report that indicates a non-zero coefficient (NZC) selection bitmap, an NZC selection bitmap size for a TRP of the multiple TRPs being based at least in part on a scaling factor configured via higher layer signaling and a set of parameters associated with the TRP. Numerous other aspects are described.

### FIELD OF THE DISCLOSURE

Aspects of the present disclosure generally relate to wireless communication and to techniques and apparatuses for coherent joint transmission (CJT) channel state information (CSI) feedback reporting for multiple transmit receive points (TRPs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive one or more reference signals from multiple transmit receive points (TRPs) associated with a network node; and transmit, to the network node and based at least in part on the one or more reference signals, a coherent joint transmission (CJT) Type II channel state information (CSI) feedback report that indicates a non-zero coefficient (NZC) selection bitmap, an NZC selection bitmap size for a TRP of the multiple TRPs being based at least in part on a scaling factor configured via higher layer signaling and a set of parameters associated with the TRP.

In some implementations, an apparatus for wireless communication at a network node includes a memory and one or more processors, coupled to the memory, configured to: transmit, to a UE, one or more reference signals from multiple TRPs associated with the network node; and receive, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

In some implementations, a method of wireless communication performed by a UE includes receiving one or more reference signals from multiple TRPs associated with a network node; and transmitting, to the network node and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

In some implementations, a method of wireless communication performed by a network node includes transmitting, to a UE, one or more reference signals from multiple TRPs associated with the network node; and receiving, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

In some implementations, a non-transitory computer-readable medium storing a set of instructions for wireless communication includes one or more instructions that, when executed by one or more processors of a UE, cause the UE to: receive one or more reference signals from multiple TRPs associated with a network node; and transmit, to the network node and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

In some implementations, a non-transitory computer-readable medium storing a set of instructions for wireless communication includes one or more instructions that, when executed by one or more processors of a network node, cause the network node to: transmit, to a UE, one or more reference signals from multiple TRPs associated with the network node; and receive, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

In some implementations, an apparatus for wireless communication includes means for receiving one or more reference signals from multiple TRPs associated with a network node; and means for transmitting, to the network node and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

In some implementations, an apparatus for wireless communication includes means for transmitting, to a UE, one or more reference signals from multiple TRPs associated with the apparatus; and means for receiving, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of enhanced Type 2 (eType II) channel state information (CSI) feedback, in accordance with the present disclosure.

FIG. 5 is a diagram illustrating an example of coherent joint transmission (CJT) Type II CSI feedback, in accordance with the present disclosure.

FIG. 6 is a diagram illustrating an example of CSI for Type II CSI feedback, in accordance with the present disclosure.

FIGS. 7-9 are diagrams illustrating examples associated with CJT CSI feedback reporting for multiple transmit receive points (TRPs), in accordance with the present disclosure.

FIGS. 10-11 are diagrams illustrating example processes associated with CJT CSI feedback reporting for multiple TRPs, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

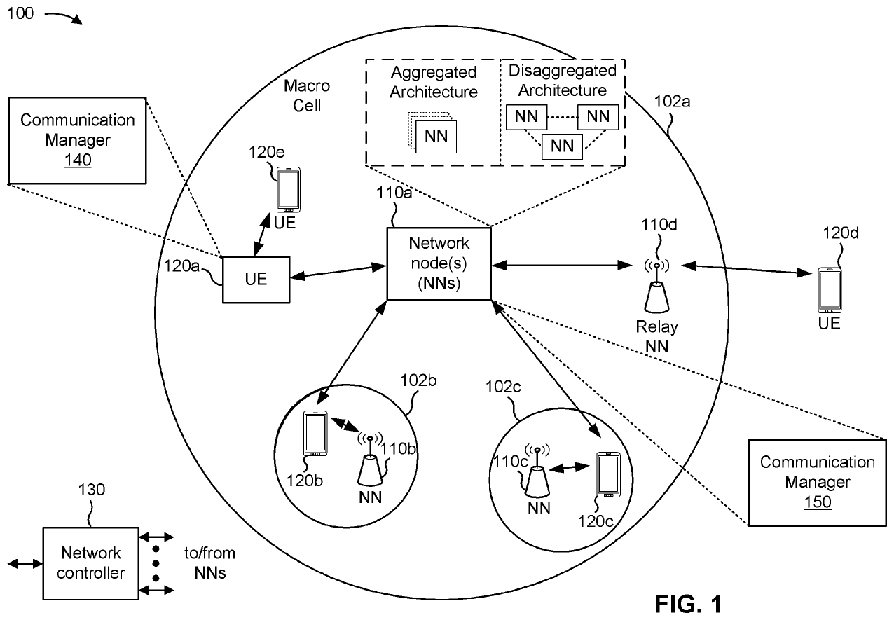

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (or transmit receive point) (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g, UE 120) may include a communication manager 140. As described in more detail elsewhere herein, the communication manager 140 may receive one or more reference signals from multiple TRPs associated with a network node; and transmit, to the network node and based at least in part on the one or more reference signals, a coherent joint transmission (CJT) Type II channel state information (CSI) feedback report that indicates a non-zero coefficient (NZC) selection bitmap, an NZC selection bitmap size for a TRP of the multiple TRPs being based at least in part on a scaling factor configured via higher layer signaling and a set of parameters associated with the TRP. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, one or more reference signals from multiple transmit TRPs associated with the network node; and receive, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP. Additionally, or alternatively, the communication manager 150 may perform one or more other operations described herein.

As indicated above, FIG. 1 is provided as an example. Other examples may differ from what is described with regard to FIG. 1.

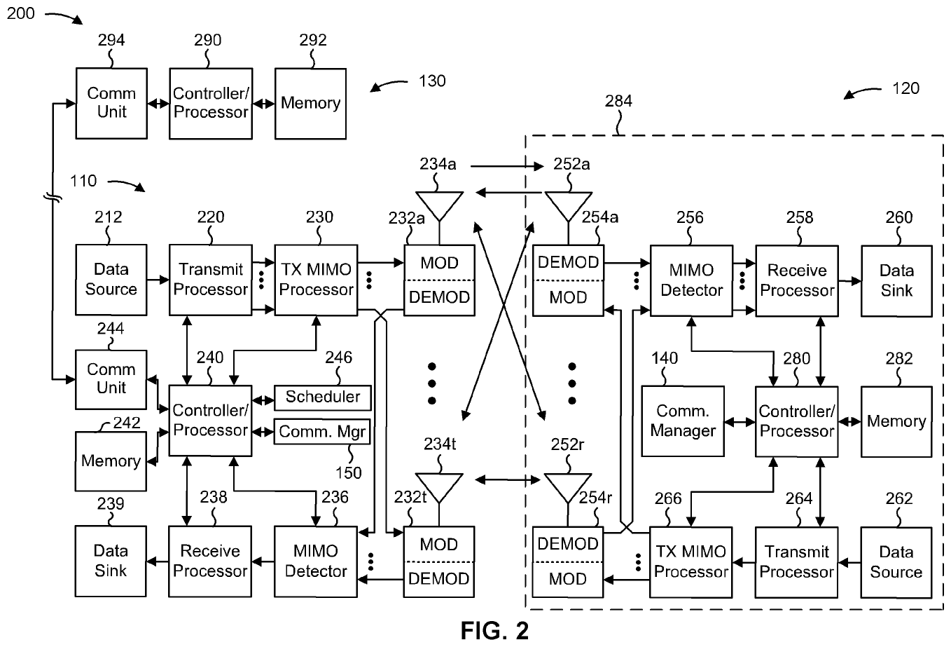

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

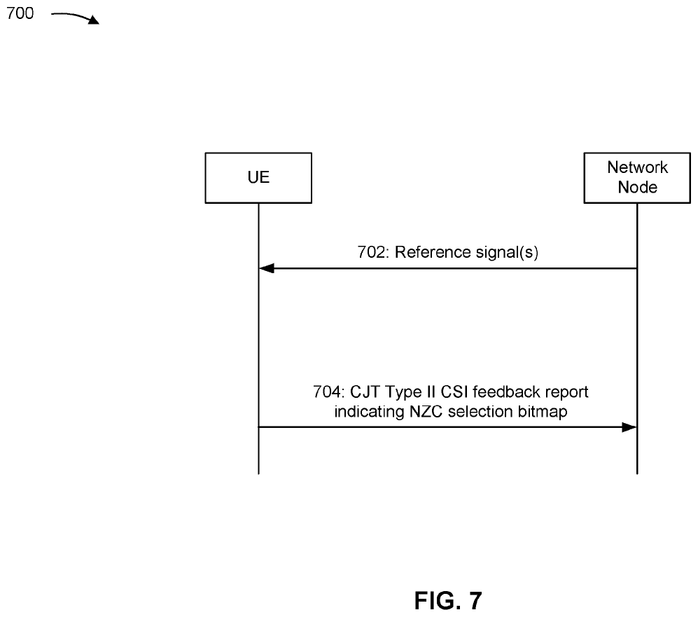

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-13).

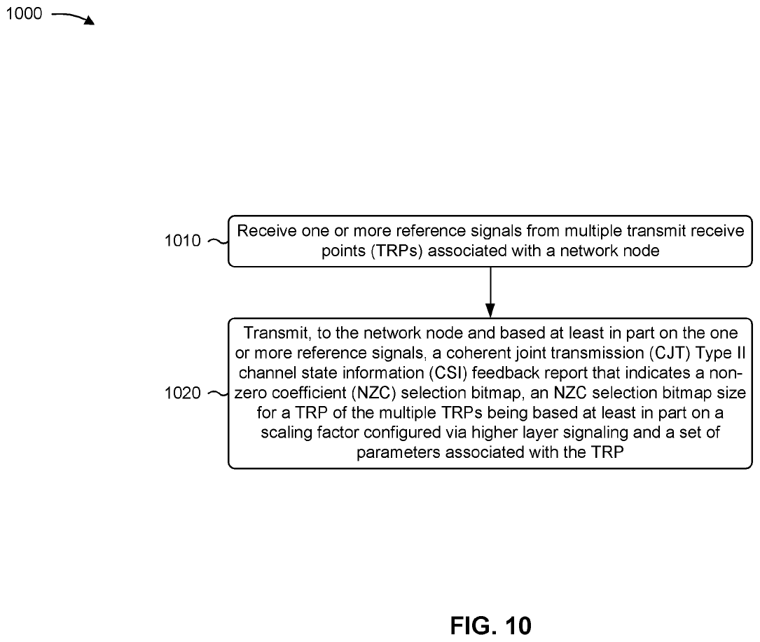

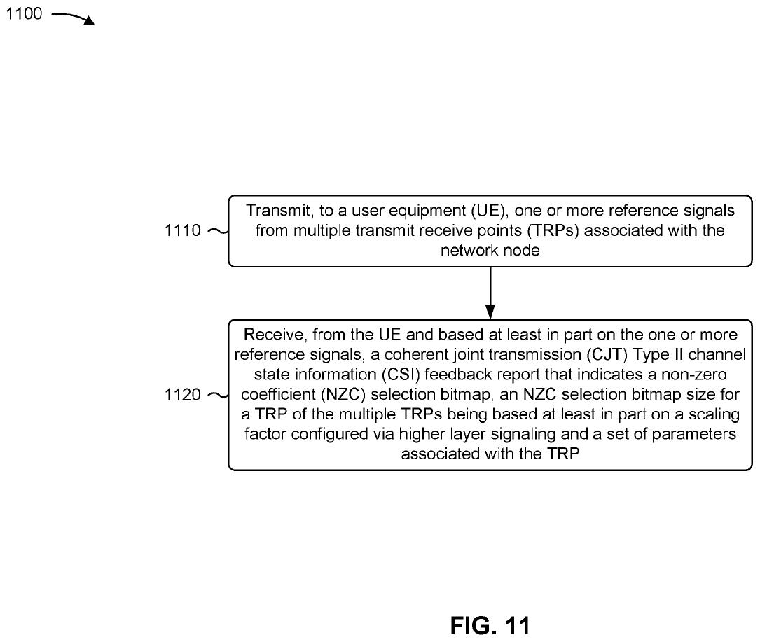

The controller/processor 240 of the network node 110, the controller/processor 280 of the UE 120, and/or any other component(s) of FIG. 2 may perform one or more techniques associated with CJT CSI feedback reporting for multiple TRPs, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., UE 120) includes means for receiving one or more reference signals from multiple TRPs associated with a network node; and/or means for transmitting, to the network node and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, one or more reference signals from multiple TRPs associated with the network node; and/or means for receiving, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

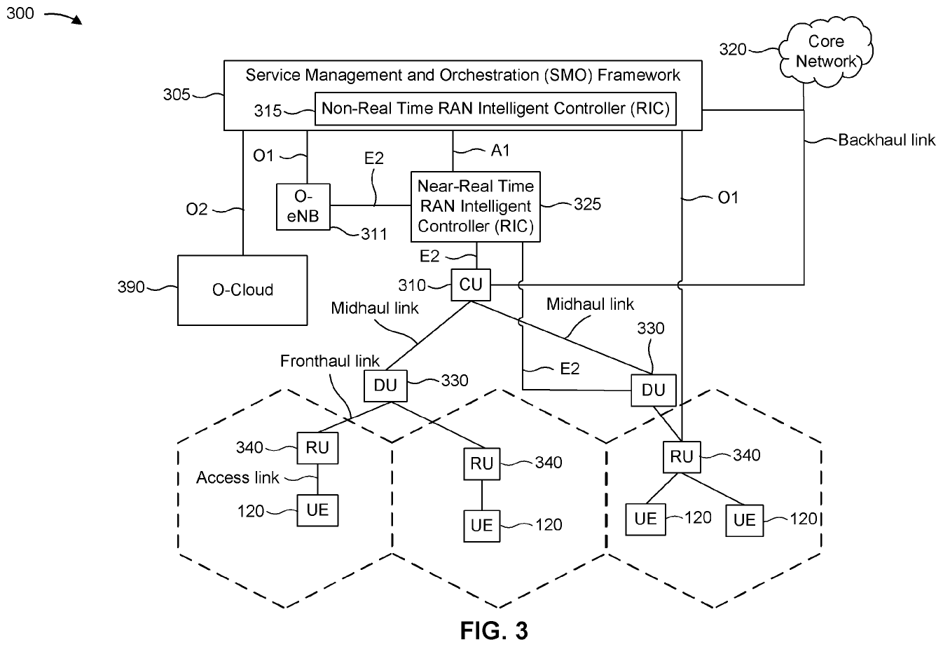

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CL 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A UE may transmit enhanced Type 2 (eType II) CSI feedback based at least in part on a spatial domain (SD) compression and a frequency domain (FD) compression via a linear combination of discrete Fourier transform (DFT) bases. The eType II CSI feedback may be an NR Release 16 eType II CSI feedback. The UE may transmit the eType II CSI feedback for a single TRP. The eType II CSI feedback may be based at least in part on a codebook structure, in which precoders for a layer l across N₃ precoding matrix indicator (PMI) subbands may be given by size-Nₜ×N₃ matrix

$${W}^{( l )} = {W}_{1} {\tilde{W}}_{2 , l} {W}_{f , l}^{H} ,$$

where Nₜ and N₃ are integer values denoting the number of transmission antenna ports and the number of PMI subbands, respectively. An SD basis W₁ (DFT bases) may be layer-common, and the UE may select/beams, where L may be RRC configured. An FD basis W_{f,l}^{H} (DFT bases) may be layer-specific, and the UE may select M bases out of candidate N₃ bases and report the selection for each layer. For coefficients \tilde{W}_{2,l}, for each layer, the UE may report up to (non-zero) K₀ coefficients, where K₀ may be RRC configured. Across a plurality of layers (e.g., all layers), the UE may report up to (non-zero) 2K₀ coefficients. The UE may set unreported coefficients to zero. The UE may report a coefficient selection (e.g., a location of NZCs within \tilde{W}_{2,l}) and a quantization of the NZCs for each layer.

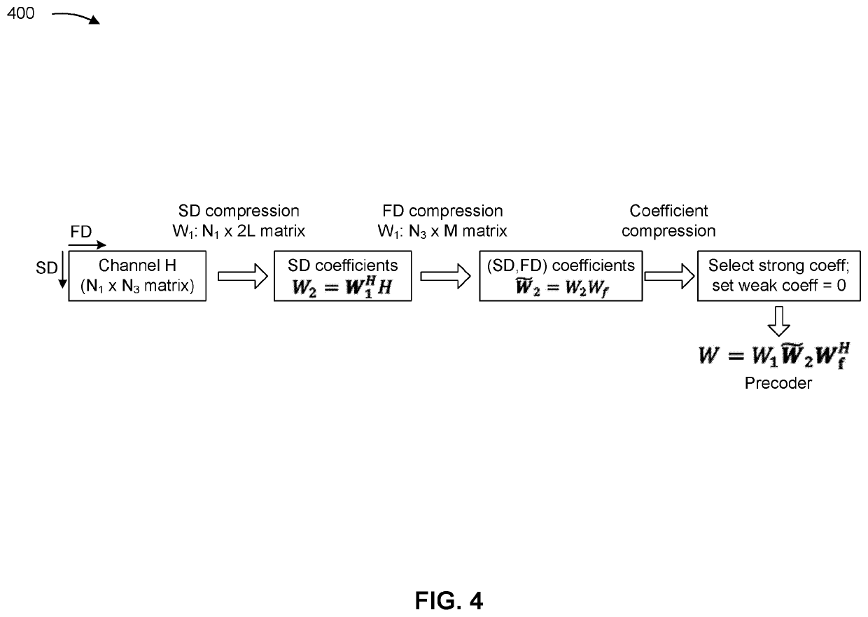

FIG. 4 is a diagram illustrating an example 400 of eType II CSI feedback, in accordance with the present disclosure.

As shown in FIG. 4, for a channel H, which may be associated with an Nₜ×N₃ matrix, a UE may perform an SD compression, which may result in W₁, which may be an Nₜ×2L matrix. The UE may determine SD coefficients based at least in part on

$${W}_{2} = {W}_{1}^{H} H .$$

The UE may perform an FD compression, which may result in W_{f}, which may be an N₃×M matrix. The UE may determine (SD, FD) coefficients based at least in part on \tilde{W}₂=W₂W_{f}. In other words, the UE may determine SD coefficients and FD coefficients based at least in part on W₂=W₂W_{f}. The UE may perform a coefficient compression, in which the UE may select strongest coefficients and set weakest coefficients to zero, which may result in a precoder in accordance with

$$W = {W}_{1} {\tilde{W}}_{2 , l} {W}_{f}^{H} .$$

The precoder may be used to form a codebook structure, which may be used by the UE when transmitting eType II CSI feedback.

As indicated above, FIG. 4 is provided as an example. Other examples may differ from what is described with regard to FIG. 4.

A network entity may transmit data to a UE using CJT across multiple TRPs (mTRP), which may improve coverage and an average throughput with high performance backhaul and synchronization. The UE may transmit CJT Type II CSI feedback which may be based at least in part on a codebook structure. In a first option, the codebook structure may be based at least in part on a joint FD compression across TRPs. A precoder (P) for CJT across two TRPs may be given by:

$$P = [ \begin{matrix}{P}_{1} \\ {P}_{2}\end{matrix} ] = [ \begin{matrix}{W}_{1 , 1} & 0 \\ 0 & {W}_{1 , 2}\end{matrix} ] {\tilde{W}}_{2} {W}_{f}^{H} ,$$

where P₁ and P₂ are TRP-specific Type II precoders, and W_{1,1} and W_{1,2} are SD compression matrices for a first TRP and a second TRP, respectively.

In a second option, the codebook structure may be based at least in part on a per-TRP FD compression and co-amplitude/phase across TRPs. A precoder (P) for CJT across two TRPs may be given by:

$$P = [ \begin{matrix}{P}_{1} \\ {qP}_{2}\end{matrix} ] = [ \begin{matrix}{W}_{1 , 1} {\tilde{W}}_{2 , 1} {W}_{f , 1}^{H} \\ {qW}_{1 , 2} {\tilde{W}}_{2 , 2} {W}_{f , 2}^{H}\end{matrix} ] ,$$

where P₁ and P₂ are TRP-specific Type II precoders, and q is an inter-TRP co-amplitude/phase.

A Type II codebook for CJT for multiple TRPs may be associated with a first mode (mode 1) or a second mode (mode 2). The first mode may be based at least in part on a per-TRP or TRP group SD/FD basis selection, which may allow an independent FD basis selection across N TRPs or N TRP groups. The first mode may be formulated in accordance with:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ] .$$

The second mode may be based at least in part on a per-TRP or TRP group (port group or resource) SD basis selection and a common/joint (across N TRPs) FD basis selection. The second mode may be formulated in accordance with:

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ] .$$

A per-TRP SD/FD basis selection may be associated with CJT across multiple TRPs. A number of SD bases may be the same or different for each TRP, but with a fixed sum. For example, for a two TRP case, L₁≠L₂ and L₁+L₂=Lₜₒₜₐₗ, where Lₜₒₜₐₗ is an RRC configured total number of SD bases. The number of FD bases My may also be the same or different for each TRP, depending on the first mode or the second mode. Additional per-TRP/polarization amplitude scaling and/or inter-TRP co-phase q may be needed and reported as part of W₂.

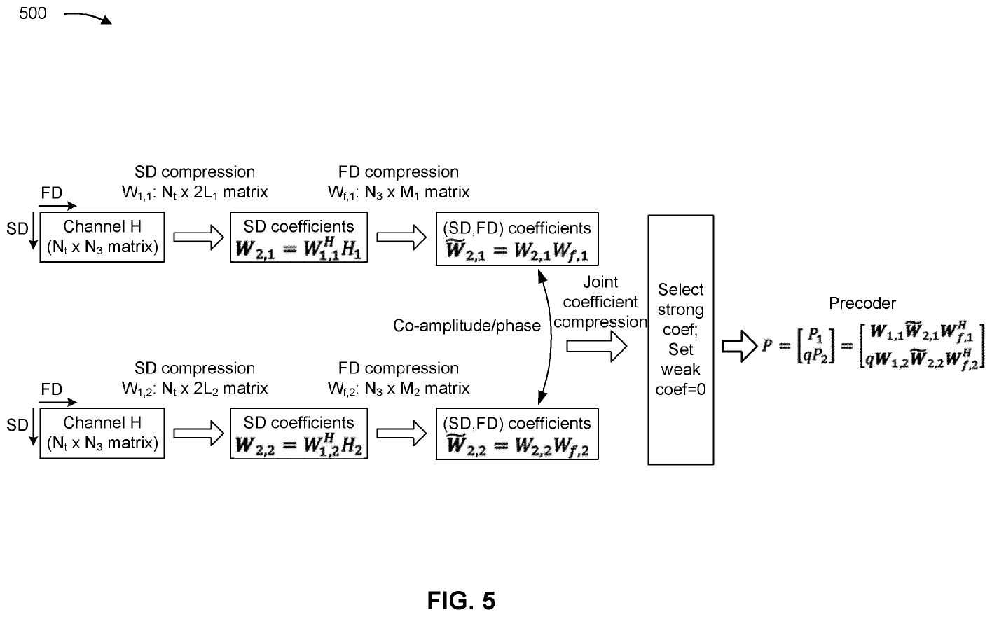

FIG. 5 is a diagram illustrating an example 500 of CJT Type II CSI feedback, in accordance with the present disclosure.

As shown in FIG. 5, for a first TRP, a channel H₁ may be associated with an Nₜ×N₃ matrix. A UE may perform an SD compression, which may result in W_{1,1}, which may be an Nₜ×2L₁ matrix. The UE may determine SD coefficients based at least in part on

$${W}_{2 , 1} = {W}_{1 , 1}^{H} {H}_{1} .$$

The UE may perform an FD compression, which may result in W_{f,1}, which may be an N₃×M₁ matrix. The UE may determine (SD, FD) coefficients based at least in part on \tilde{W}_{2,1}=W_{2,1}W_{f,1}. For a second TRP, a channel H₂ may be associated with an Nₜ×N₃ matrix. The UE may perform an SD compression, which may result in W_{1,2}, which may be an Nₜ×2L₂ matrix. The UE may determine SD coefficients based at least in part on

$${W}_{2 , 2} = {W}_{1 , 2}^{H} {H}_{2} .$$

The UE may perform an FD compression, which may result in W_{f,2}, which may be an N₃×M₂ matrix. The UE may determine (SD, FD) coefficients based at least in part on \tilde{W}_{2,2}=W_{2,2}W_{f,2}. An inter-TRP co-amplitude/phase (q) may be based at least in part on the (SD, FD) coefficients for the first TRP, which may be associated will

$${W}_{2 , 1} = {W}_{1 , 1}^{H} {H}_{1} ,$$

and the (SD, FD) coefficients for the second TRP, which may be associated with \tilde{W}_{2,2}=W_{2,2}W_{f,2}. The UE may perform a joint coefficient compression based at least in part on the (SD, FD) coefficients for the first TRP and the (SD, FD) coefficients for the second TRP. The UE may perform the joint coefficient compression, in which the UE may select strongest coefficients and set weakest coefficients to zero, which may result in a precoder in accordance with:

$$P = [ \begin{matrix}{P}_{1} \\ {qP}_{2}\end{matrix} ] = [ \begin{matrix}{W}_{1 , 1} {\tilde{W}}_{2 , 1} {W}_{f , 1}^{H} \\ {qW}_{1 , 2} {\tilde{W}}_{2 , 2} {W}_{f , 2}^{H}\end{matrix} ] ,$$

where the precoder may be used to form a codebook structure, which may be used by the UE when transmitting CJT Type II CSI feedback.

As indicated above, FIG. 5 is provided as an example. Other examples may differ from what is described with regard to FIG. 5.

A CSI part 1 and a CSI part 2 may be associated with Type II CSI. CSI may be divided into two parts (e.g., part 1 and part 2) due to a relatively large payload size. In other words, the CSI may be reported in the two different parts. CSI part 1 may be more significant and may have a smaller and fixed payload, as compared to CSI part 2. CSI part 1 may be transmitted with higher reliability as compared to CSI part 2. CSI part 2 may have a variable payload size, which may be dependent on the content of CSI part 1. As an example, for Type II CSI, a payload size of CSI part 2 may be based at least in part on a rank indicator (RI), a CQI, and a number of non-zero coefficients (NNZC) in CSI part 1.

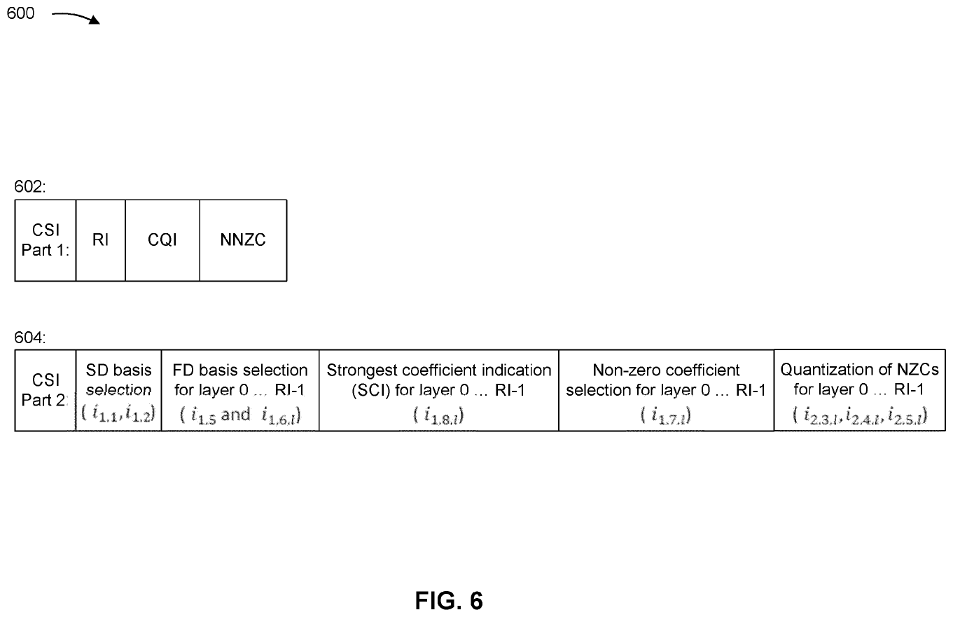

FIG. 6 is a diagram illustrating an example 600 of CSI for Type II CSI feedback, in accordance with the present disclosure.

As shown by reference number 602, CSI part 1 may indicate RI, CQI, and NNZC. As shown by reference number 604, CSI part 2 may indicate an SD basis selection (i_{1,1}, i_{1,2}). The UE may select L beams out of N₁N₂O₁O₂ total beams for W₁, where i_{1,1}: log₂O₁O₂ for beam group and i_{1,2}:

$$⌈ {log}_{2} ( \begin{matrix}{N}_{1} {N}_{2} \\ L\end{matrix} ) ⌉$$

for beam indication. The CSI part 2 may indicate an FD basis selection for layer 0 . . . . RI-1 (i_{1,5} and i_{1,6,l}). The UE may select M FD bases out of N₃ bases for W_{f} per layer. The CSI part 2 may indicate a strongest coefficient indication for layer 0 . . . . RI-1 (i_{1,8,l}). The UE may indicate the locations of strongest coefficient in \tilde{W}₂ per layer. The CSI part 2 may indicate a non-zero coefficient selection for layer 0 . . . . RI-1 (i_{1,7,l}). The UE may indicate the location of NZCs within \tilde{W}₂ per layer by bitmap. The CSI part 2 may indicate a quantization of NZCs for layer 0 . . . . RI-1 (i_{2,3,l}, i_{2,4,l}, i_{2,5,l}). The UE may indicate amplitude/phase quantization for NZCs (differential quantization based at least in part on the strongest coefficient indication). Further, the 3GPP standard may define notations correspond to i_{1,1}, i_{1,2}, i_{1,5}, i_{1,6,l}, i_{1,7,l}, i_{1,8,l}, i_{2,3,l}, i_{2,4,l}, i_{2,5,l}.

As indicated above, FIG. 6 is provided as an example. Other examples may differ from what is described with regard to FIG. 6.

For an NZC selection (i_{1,7,l}), which may be indicated in CSI (e.g., CSI part 2), the location of NZCs in \tilde{W}₂ per layer may be indicated by a bitmap for Type-II CSI. A bitmap per layer may have a size of 2LMᵥ where L and Mᵥ are the number of SD and FD bases, respectively, and the constant “2” indicates two polarizations. A bit value of “1” may indicate that the corresponding coefficient is non-zero and that a corresponding amplitude/phase quantization are reported, and a bit value of “0” may indicate a zero and not reported coefficient. For a Type II codebook refinement for CJT for multiple TRPs, regarding the location of NZCs indicated by bitmap, a separate bitmap per each channel state information reference signal (CSI-RS) may be supported for each layer. A total size may correspond to

$${\sum }_{n = 1}^{N} {B}_{n}$$

where Bₙ is the bitmap size for CSI-RS resource n. Further, Bₙ=2LₙM_{v,n} (M_{v,n}=Mᵥ for mode 2) may be analogous to a legacy approach. A per-CSI-RS resource NNZC constraint may be defined, or a joint NNZC constraint across a defined quantity of CSI-RS resources may be defined. Each CSI-RS resource may be associated with one TRP for CJT, (e.g., CSI-RS source n may correspond to a TRP n). The feedback bits for an NZC selection bitmap for CJT may be scaled with the number of TRPs, especially when Bₙ=2Lₙ M_{v,n}.

An NZC selection overhead may be reduced based at least in part on the priority of coefficients. NZCs may be selected from high priority coefficients, and low priority coefficients may not be reported and may be set to zero values. A resulting total bitmap size may be equal to the number of the highest priority coefficients, which may be configured by higher layer signaling, while considering a tradeoff between performance and overhead. However, this approach may be based at least in part on a joint NZC selection across TRPs using a single bitmap. The use of the single bitmap may not align with a notion to support a separate bitmap per each CSI-RS resource (or TRP), because a priority of a coefficient may be determined by sorting a plurality of candidate coefficients across a plurality of TRPs, layers, SD bases, and FD bases. Thus, an NZC selection solution that supports a separate bitmap per each CSI-RS resource (or TRP) and with reduced signaling overhead may be desired.

In various aspects of techniques and apparatuses described herein, a UE may receive one or more reference signals from multiple TRPs associated with a network node. The UE may transmit, to the network node and based at least in part on the one or more reference signals, a CJT Type II CSI feedback report that indicates an NZC selection bitmap. The NZC selection bitmap size for a TRP may be based at least in part on a scaling factor configured via higher layer signaling and a set of parameters associated with the TRP. In some aspects, the UE may report, via the NZC selection bitmap, an NZC selection for CJT for multiple TRPs with an overhead reduction. The NZC selection bitmap may be a separate bitmap, which may be enabled per TRP for NZC selection reporting with a reduced bitmap size (e.g., Bₙ<2LₙM_{v,n}). The reduced bitmap size may reduce a signaling overhead for the UE, thereby enabling the UE to save power.

FIG. 7 is a diagram illustrating an example 700 associated with CJT CSI feedback reporting for multiple TRPs, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE may receive one or more reference signals from multiple TRPs associated with the network node. The one or more reference signals may include CSI-RSs. For example, the UE may receive a first CSI-RS from a first TRP, of the multiple TRPs, and the UE may receive a second CSI-RS from a second TRP, of the multiple TRPs.

As shown by reference number 704, the UE may transmit, to the network node and based at least in part on the one or more reference signals, a CJT Type II CSI feedback report that indicates an NZC selection bitmap. An NZC selection bitmap size for a TRP (e.g., an NZC selection bitmap size per TRP) may be based at least in part on a scaling factor configured via higher layer signaling and a set of parameters associated with the TRP (e.g., TRP n). The set of parameters may include a number of polarizations (e.g., two polarizations), an RI, a number of SD bases associated with the TRP (Lₙ), and a number of FD bases associated with the TRP (M_{v,n}). The scaling factor may be common for the multiple TRPs. The scaling factor may be rank-pair specific. The NZC selection bitmap size may not be less than a maximum total number of NZCs across the plurality of layers per TRP.

In some aspects, the NZC selection bitmap size across the plurality of layers (e.g., all layers) for TRP n may be based at least in part on Bₙ=α·2·RI·Lₙ·M_{v,n}, where α is configured by the higher layer signaling, and Bₙ is the bitmap size for CSI-RS resource n or TRP n. The value of a may be common for the multiple TRPs (e.g., all TRPs), but may be rank-pair specific. For example, one value may be defined for an RI of 1 or 2, and another value may be defined for an RI of 3 or 4. The NZC selection bitmap size may be no less than a maximum total number of NZCs per TRP. For example, Bₙ=max (K₀, α·2·RI·LₙM_{v,n}), where K₀ is the maximum total NNZCs across a plurality of layers (e.g., all layers) for a certain TRP.

In some aspects, the NZC selection bitmap may be associated with an NZC selection. A quantity of coefficients associated with the TRP may be sorted using a priority function for a single TRP prior to the NZC selection. The quantity of coefficients may be based at least in part on a number of polarizations (e.g., two polarizations), an RI, a number of SD bases associated with the TRP, and a number of FD bases associated with the TRP. A coefficient of the quantity of coefficients may be associated with a layer index, an SD basis index, and a permutated FD basis index. A priority level for the quantity of coefficients may be based at least in part on an order of layer, SD basis, and permutated FD basis.

In some aspects, before the NZC selection, the total 2·RI·Lₙ·M_{v,n} coefficients of TRP n may be sorted using an existing priority function for the single TRP. A coefficient

$${c}_{{i}_{1} , {m}_{1}}^{( {l}_{1} )}$$

may have a lower priority than

$${c}_{{i}_{2} , {m}_{2}}^{( {l}_{2} )}$$

if Prio(l₁, i₁, m₁)>Pri (l₂, i₂, m₂), where l indicates the layer index, i indicates the SD basis index, and m indicates the permutated FD basis index. The priority level may be defined based at least in part on the order of layer, SD basis, and permutated FD basis, respectively. For example, a layer may have a higher priority than an SD basis, and an SD basis may have a higher priority than an FD basis. For example, Prio(l, i, m)=2L·RI·Per (m)+RI·i+l, where Per (m)=min (2m, 2(N₃−m)−1). As such, an FD basis may be mapped following the order: 0, N₃-1, l, N₃-2, 2, . . . , such that coefficients relatively close to FD basis 0 are likely to be more important than other coefficients. When an FD basis of the strongest coefficient of layer I is not FD basis 0, then an FD basis remapping per TRP per layer may be applied. For example,

$${\tilde{k}}_{{m}_{l}} = mod ( {k}_{{m}_{l}} - {k}_{{m}_{l}}^{*} , {N}_{3} ) and {\tilde{k}}_{{m}_{l}}^{*} = 0 ,$$

where

$${k}_{{m}_{l}}^{*}$$

is an FD basis index of the strongest coefficient before the FD basis remapping.

In some aspects, the NZC selection bitmap may be associated with an NZC selection. The NZC selection of the TRP may be performed across high priority coefficients of the TRP. Each bit in the NZC selection bitmap may correspond to one of the high priority coefficients. The NZC selection of the TRP may not be performed across low priority coefficients for the TRP. The low priority coefficients for the TRP may not be reported and may be set to zero values. Non-zero bits in the NZC selection bitmap may indicate NZCs reported for the TRP across the plurality of layers.

In some aspects, the NZC selection of TRP n may be performed across the high priority coefficients. Each bit in the NZC selection bitmap may correspond to one of the Bₙ highest priority coefficients. Low priority coefficients for each TRP may not be reported and may be set to zero values in \tilde{W}₂. The non-zero bits in the NZC selection bitmap may identify the NZCs reported for TRP n across the plurality of layers (e.g., all layers).

In some aspects, the NZC selection bitmap may be associated with the TRP and may be partitioned to form a first group and a second group. The first group may include a quantity of highest priority bits in the NZC selection bitmap and a quantity of highest priority NZCs. The second group may include a remaining quantity of lowest priority bits in the NZC selection bitmap and a quantity of lowest priority NZCs. The NZC selection bitmap may be partitioned based at least in part on an NZC selection and quantization. The NZC selection bitmap may be partitioned to maintain a non-zero PMI based at least in part on the second group being omitted due to insufficient physical uplink shared channel (PUSCH) resources for CJT Type II CSI feedback reporting. In some aspects, a number of NZCs across the plurality of layers per TRP may be reported in a CSI part 1. A size of a bitmap in the first group may be based at least in part on the number of NZCs across the plurality of layers per TRP reported in the CSI part 1. In some aspects, the number of NZCs across the plurality of layers per TRP may not be reported in the CSI part 1. A total number of NZCs across the plurality of layers and a quantity of cooperated TRPs may be reported in the CSI part 1, where a size of a bitmap in the first group may be based on at least the total number of NZCs across the plurality of layers and the quantity of cooperated TRPs reported in the CSI part 1.

In some aspects, the NZC selection bitmap (e.g., a bitmap associated with NZCs) of TRP n may be partitioned into the two groups (e.g., the first group and the second group) to maintain the non-zero PMI, when the second group is omitted due to insufficient PUSCH resources for CSI reporting. When the number of NZCs across the plurality of layers (e.g., all layers) per TRP are reported in the CSI part 1, which may be denoted as

$${K}_{n}^{NZ}$$

for TRP n, the first group may include

$${B}_{n} - ⌊ \frac{{K}_{n}^{NZ}}{2} ⌋$$

$$⌈ \frac{{K}_{n}^{NZ}}{2} ⌉$$

highest priority NZCs, where By is the NZC in the NZC selection bitmap and selection bitmap size for TRP n. Further, the second group may include the remaining

$$⌊ \frac{{K}_{n}^{NZ}}{2} ⌋$$

lowest priority bits in the NZC selection bitmap and

$$⌊ \frac{{K}_{n}^{NZ}}{2} ⌋$$

lowest priority NZCs. When the number of NZCs per TRP are not reported in the CSI part 1 but instead a total number of NZCs across the plurality of layers (e.g., all layers) and N cooperated TRPs are reported in the CSI part 1

$$( e . g . , {K}_{tot}^{NZ} = {\sum }_{n = 1}^{N} {K}_{n}^{NZ} )$$

the first group may include

$${B}_{n} - ⌊ \frac{{K}_{tot}^{NZ}}{2 N} ⌋$$

highest priority bits in the NZC selection bitmap and

$$⌈ \frac{{K}_{n}^{NZ}}{2} ⌉$$

highest priority NZCs. Further the second group may include the remaining

$$⌊ \frac{{K}_{n}^{NZ}}{2 N} ⌋$$

lowest priority bits in the NZC selection bitmap and

$$⌊ \frac{{K}_{n}^{NZ}}{2} ⌋$$

lower priority NZCs.

As indicated above, FIG. 7 is provided as an example. Other examples may differ from what is described with regard to FIG. 7.

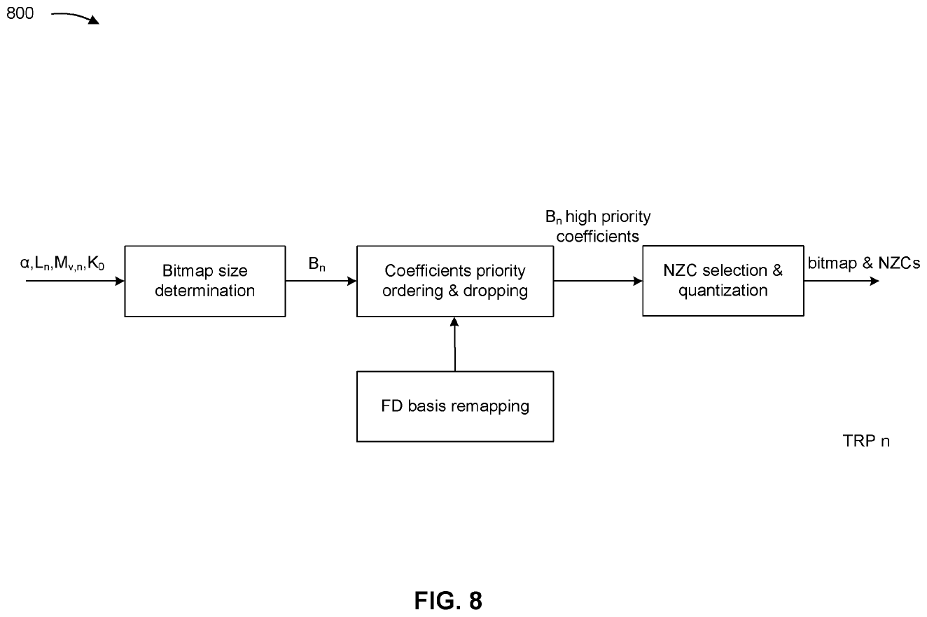

FIG. 8 is a diagram illustrating an example 800 associated with CJT CSI feedback reporting for multiple TRPs, in accordance with the present disclosure.

As shown in FIG. 8, for a TRP n, a UE may perform an NZC selection bitmap size determination, which may be based at least in part on a, Lₙ, M_{v,n}, and K₀. The UE may determine the NZC selection bitmap size (Bₙ). The UE may perform coefficients priority ordering and dropping, which may be based at least in part on the NZC selection bitmap size and an FD basis remapping. The UE may determine Bₙ high priority coefficients based at least in part on the coefficient priority ordering and dropping. Depending on the Bₙ high priority coefficients, the UE may perform an NZC selection and quantization. The UE may determine an NZC selection bitmap (e.g., a bitmap associated with NZCs) based at least in part on NZC selection and quantization. The NZC selection bitmap may be a separate bitmap per TRP for NZC selection. The UE may report the NZC selection bitmap (e.g., an NZC selection) to a network node. The NZC selection bitmap may be associated with CJT for multiple TRPs, and may be associated with an overhead reduction.

As indicated above, FIG. 8 is provided as an example. Other examples may differ from what is described with regard to FIG. 8.

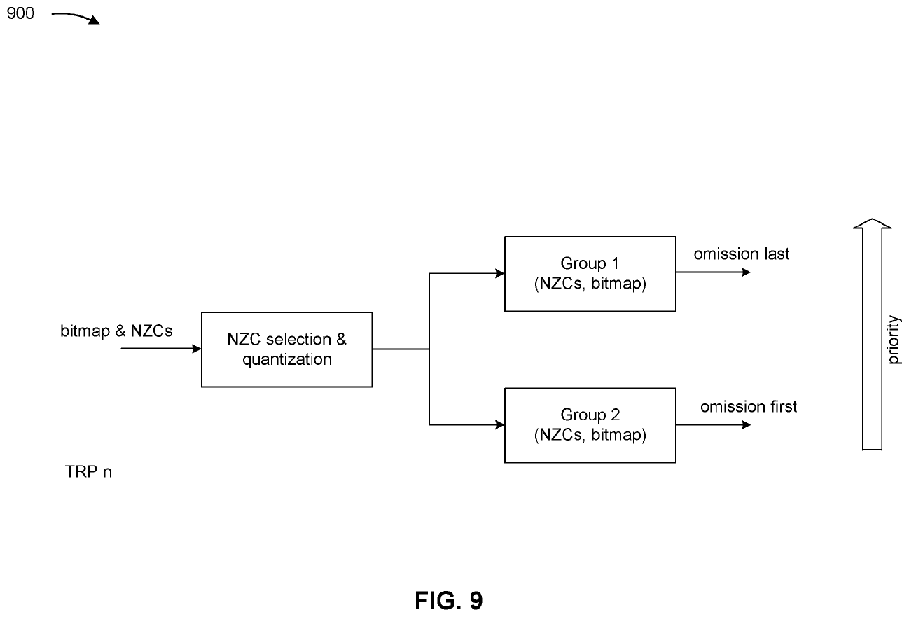

FIG. 9 is a diagram illustrating an example 900 associated with CJT CSI feedback reporting for multiple TRPs, in accordance with the present disclosure.

As shown in FIG. 9, for a TRP n, a UE may obtain an NZC selection bitmap (e.g., a bitmap associated with NZCs). The UE may perform NZC selection and quantization to the NZC selection bitmap, which may result in a partitioning of the NZC selection bitmap into two groups. A first group of the two groups may be associated with certain NZCs and a certain portion of the NZC selection bitmap. For example, the first group may be associated with highest priority bits in the NZC selection bitmap and highest priority NZCs. A second group of the two groups may be associated with certain NZCs and a certain portion of the NZC selection bitmap. For example, the second group may be associated with lowest bits in the NZC selection bitmap and lowest priority NZCs. The highest priority bits and the lowest priority bits may be identified from the NZC selection bitmap. The highest priority NZCs and the lowest priority NZCs may be identified from the NZCs. Contents of the second group may be omitted first, and contents of the first group may be omitted last, in relation to the second group.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with CJT CSI feedback reporting for multiple TRPs.

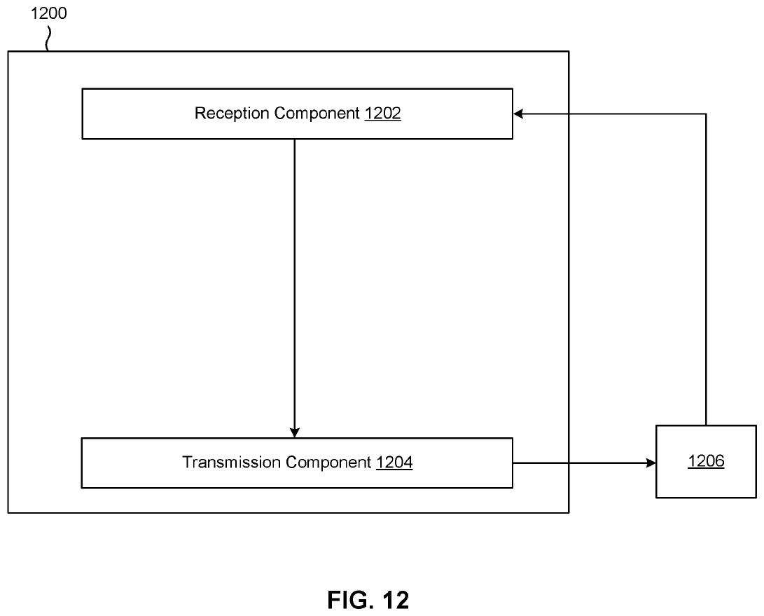

As shown in FIG. 10, in some aspects, process 1000 may include receiving one or more reference signals from multiple TRPs associated with a network node (block 1010). For example, the UE (e.g., using reception component 1202, depicted in FIG. 12) may receive one or more reference signals from multiple TRPs associated with a network node, as described above.

As further shown in FIG. 10, in some aspects, process 1000 may include transmitting, to the network node and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP (block 1020). For example, the UE (e.g., using transmission component 1204, depicted in FIG. 12) may transmit, to the network node and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP, as described above.

Process 1000 may include additional aspects, such as any single aspect or any combination of aspects described below and/or in connection with one or more other processes described elsewhere herein.

In a first aspect, the set of parameters includes a number of polarizations, an RI, a number of SD bases associated with the TRP, and a number of FD bases associated with the TRP.

In a second aspect, alone or in combination with the first aspect, the scaling factor is common for the multiple TRPs, and the scaling factor is rank-pair specific.

In a third aspect, alone or in combination with one or more of the first and second aspects, the NZC selection bitmap size is not less than a maximum total number of NZCs across a plurality of layers per TRP.

In a fourth aspect, alone or in combination with one or more of the first through third aspects, the NZC selection bitmap is associated with an NZC selection, and a quantity of coefficients associated with the TRP are sorted using a priority function for a single TRP prior to the NZC selection.

In a fifth aspect, alone or in combination with one or more of the first through fourth aspects, the quantity of coefficients is based at least in part on a number of polarizations, an RI, a number of SD bases associated with the TRP, and a number of FD bases associated with the TRP.

In a sixth aspect, alone or in combination with one or more of the first through fifth aspects, a coefficient of the quantity of coefficients is associated with a layer index, an SD basis index, and a permutated FD basis index, and a priority level for the quantity of coefficients is based at least in part on an order of layer, SD basis, and permutated FD basis.

In a seventh aspect, alone or in combination with one or more of the first through sixth aspects, the NZC selection bitmap is associated with an NZC selection of the TRP, the NZC selection of the TRP is performed across high priority coefficients of the TRP, and each bit in the NZC selection bitmap corresponds to one of the high priority coefficients.

In an eighth aspect, alone or in combination with one or more of the first through seventh aspects, the NZC selection of the TRP is not performed across low priority coefficients for the TRP, and the low priority coefficients for the TRP are not reported and are set to zero values.

In a ninth aspect, alone or in combination with one or more of the first through eighth aspects, non-zero bits in the NZC selection bitmap indicate NZCs reported for the TRP across a plurality of layers.

In a tenth aspect, alone or in combination with one or more of the first through ninth aspects, the NZC selection bitmap is associated with the TRP and is partitioned to form a first group and a second group, the first group includes a quantity of highest priority bits in the NZC selection bitmap and a quantity of highest priority NZCs, and the second group includes a remaining quantity of lowest priority bits in the NZC selection bitmap and a quantity of lowest priority NZCs.

In an eleventh aspect, alone or in combination with one or more of the first through tenth aspects, the NZC selection bitmap is partitioned to maintain a non-zero PMI based at least in part on the second group being omitted due to insufficient uplink shared channel resources for CJT Type II CSI feedback reporting.

In a twelfth aspect, alone or in combination with one or more of the first through eleventh aspects, a number of NZCs across a plurality of layers per TRP is reported in a CSI part 1, and a size of a bitmap in the first group is based at least in part on the number of NZCs across the plurality of layers per TRP reported in the CSI part 1.

In a thirteenth aspect, alone or in combination with one or more of the first through twelfth aspects, a number of NZCs across a plurality of layers per TRP is not reported in a CSI part 1, a total number of NZCs across the plurality of layers and a quantity of cooperated TRPs is reported in the CSI part 1, and wherein a size of a bitmap in the first group is based at least in part on the total number of NZCs across the plurality of layers and the quantity of cooperated TRPs reported in the CSI part 1.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with CJT CSI feedback reporting for multiple TRPs.

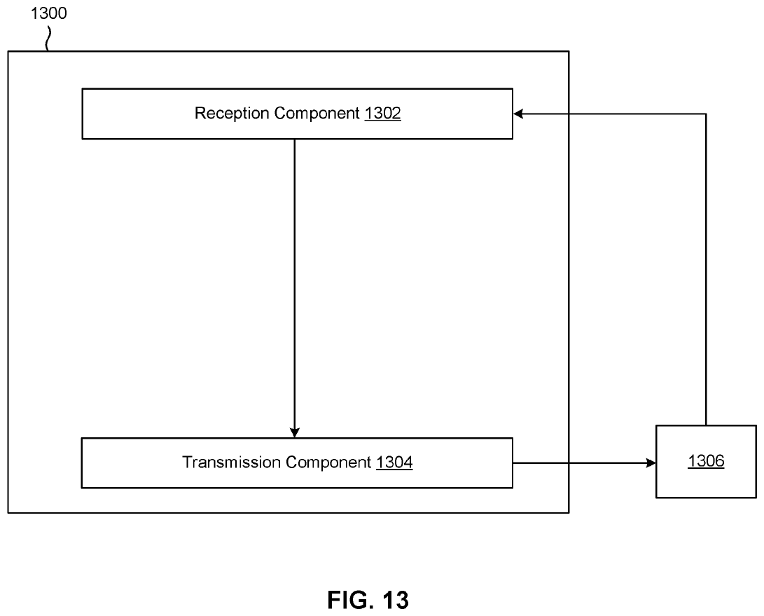

As shown in FIG. 11, in some aspects, process 1100 may include transmitting, to a UE, one or more reference signals from multiple TRPs associated with the network node (block 1110). For example, the network node (e g., using transmission component 1304, depicted in FIG. 13) may transmit, to a UE, one or more reference signals from multiple TRPs associated with the network node, as described above.

As further shown in FIG. 11, in some aspects, process 1100 may include receiving, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP (block 1120). For example, the network node (e.g., using reception component 1302, depicted in FIG. 13) may receive, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP, as described above.

Process 1100 may include additional aspects, such as any single aspect or any combination of aspects described below and/or in connection with one or more other processes described elsewhere herein.

In a first aspect, the set of parameters includes a number of polarizations, an RI, a number of SD bases associated with the TRP, and a number of FD bases associated with the TRP.

In a second aspect, alone or in combination with the first aspect, the scaling factor is common for the multiple TRPs, and the scaling factor is rank-pair specific.

In a third aspect, alone or in combination with one or more of the first and second aspects, the NZC selection bitmap size is not less than a maximum total number of NZCs across a plurality of layers per TRP.

In a fourth aspect, alone or in combination with one or more of the first through third aspects, the NZC selection bitmap is associated with an NZC selection, and a quantity of coefficients associated with the TRP are sorted using a priority function for a single TRP prior to the NZC selection.

In a fifth aspect, alone or in combination with one or more of the first through fourth aspects, the quantity of coefficients is based at least in part on a number of polarizations, an RI, a number of SD bases associated with the TRP, and a number of FD bases associated with the TRP.

In a sixth aspect, alone or in combination with one or more of the first through fifth aspects, a coefficient of the quantity of coefficients is associated with a layer index, an SD basis index, and a permutated FD basis index, and a priority level for the quantity of coefficients is based at least in part on an order of layer, SD basis, and permutated FD basis.

In a seventh aspect, alone or in combination with one or more of the first through sixth aspects, the NZC selection bitmap is associated with an NZC selection of the TRP, the NZC selection of the TRP is performed across high priority coefficients of the TRP, and each bit in the NZC selection bitmap corresponds to one of the high priority coefficients.

In an eighth aspect, alone or in combination with one or more of the first through seventh aspects, the NZC selection of the TRP is not performed across low priority coefficients for the TRP, and the low priority coefficients for the TRP are not reported and are set to zero values.

In a ninth aspect, alone or in combination with one or more of the first through eighth aspects, non-zero bits in the NZC selection bitmap indicate NZCs reported for the TRP across a plurality of layers.

In a tenth aspect, alone or in combination with one or more of the first through ninth aspects, the NZC selection bitmap is associated with the TRP and is partitioned to form a first group and a second group, the first group includes a quantity of highest priority bits in the NZC selection bitmap and a quantity of highest priority NZCs, and the second group includes a remaining quantity of lowest priority bits in the NZC selection bitmap and a quantity of lowest priority NZCs.

In an eleventh aspect, alone or in combination with one or more of the first through tenth aspects, the NZC selection bitmap is partitioned to maintain a non-zero PMI based at least in part on the second group being omitted due to insufficient uplink shared channel resources for CJT Type II CSI feedback reporting.

In a twelfth aspect, alone or in combination with one or more of the first through eleventh aspects, a number of NZCs across a plurality of layers per TRP is reported in a CSI part 1, and a size of a bitmap in the first group is based at least in part on the number of NZCs across the plurality of layers per TRP reported in the CSI part 1.

In a thirteenth aspect, alone or in combination with one or more of the first through twelfth aspects, a number of NZCs across a plurality of layers per TRP is not reported in a CSI part 1, a total number of NZCs across the plurality of layers and a quantity of cooperated TRPs is reported in the CSI part 1, and wherein a size of a bitmap in the first group is based at least in part on the total number of NZCs across the plurality of layers and the quantity of cooperated TRPs reported in the CSI part 1.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive one or more reference signals from multiple TRPs associated with a network node. The transmission component 1204 may transmit, to the network node and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit, to a UE, one or more reference signals from multiple TRPs associated with the network node. The reception component 1302 may receive, from the UE and based at least in part on the one or more reference signals, a CJT Type II CSI feedback report that indicates an NZC selection bitmap, an NZC selection bitmap size for a TRP of the multiple TRPs being based at least in part on a scaling factor configured via higher layer signaling and a set of parameters associated with the TRP.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving one or more reference signals from multiple transmit receive points (TRPs) associated with a network node; and transmitting, to the network node and based at least in part on the one or more reference signals, a coherent joint transmission (CJT) Type II channel state information (CSI) feedback report that indicates a non-zero coefficient (NZC) selection bitmap, an NZC selection bitmap size for a TRP of the multiple TRPs being based at least in part on a scaling factor configured via higher layer signaling and a set of parameters associated with the TRP.

Aspect 2: The method of Aspect 1, wherein the set of parameters includes: a number of polarizations, a rank indicator, a number of spatial domain bases associated with the TRP, and a number of frequency domain bases associated with the TRP.

Aspect 3: The method of any of Aspects 1-2, wherein the scaling factor is common for the multiple TRPs, and wherein the scaling factor is rank-pair specific.

Aspect 4: The method of any of Aspects 1-3, wherein the NZC selection bitmap size is not less than a maximum total number of NZCs across a plurality of layers per TRP.

Aspect 5: The method of any of Aspects 1-4, wherein the NZC selection bitmap is associated with an NZC selection, and wherein a quantity of coefficients associated with the TRP are sorted using a priority function for a single TRP prior to the NZC selection.

Aspect 6: The method of Aspect 5, wherein the quantity of coefficients is based at least in part on a number of polarizations, a rank indicator, a number of spatial domain bases associated with the TRP, and a number of frequency domain bases associated with the TRP.

Aspect 7: The method of Aspect 5, wherein a coefficient of the quantity of coefficients is associated with a layer index, a spatial domain (SD) basis index, and a permutated frequency domain (FD) basis index, and wherein a priority level for the quantity of coefficients is based at least in part on an order of layer, SD basis, and permutated FD basis.

Aspect 8: The method of any of Aspects 1-7, wherein the NZC selection bitmap is associated with an NZC selection of the TRP, wherein the NZC selection of the TRP is performed across high priority coefficients of the TRP, and wherein each bit in the NZC selection bitmap corresponds to one of the high priority coefficients.

Aspect 9: The method of Aspect 8, wherein the NZC selection of the TRP is not performed across low priority coefficients for the TRP, and wherein the low priority coefficients for the TRP are not reported and are set to zero values.

Aspect 10: The method of Aspect 8, wherein non-zero bits in the NZC selection bitmap indicate NZCs reported for the TRP across a plurality of layers.

Aspect 11: The method of any of Aspects 1-10, wherein the NZC selection bitmap is associated with the TRP and is partitioned to form a first group and a second group, and the first group includes a quantity of highest priority bits in the NZC selection bitmap and a quantity of highest priority NZCs, and wherein the second group includes a remaining quantity of lowest priority bits in the NZC selection bitmap and a quantity of lowest priority NZCs.

Aspect 12: The method of Aspect 11, wherein the NZC selection bitmap is partitioned to maintain a non-zero precoding matrix indicator based at least in part on the second group being omitted due to insufficient uplink shared channel resources for CJT Type II CSI feedback reporting.

Aspect 13: The method of Aspect 11, wherein a number of NZCs across a plurality of layers per TRP is reported in a CSI part 1, and wherein a size of a bitmap in the first group is based at least in part on the number of NZCs across the plurality of layers per TRP reported in the CSI part 1.

Aspect 14: The method of Aspect 11, wherein a number of NZCs across a plurality of layers per TRP is not reported in a CSI part 1, wherein a total number of NZCs across the plurality of layers and a quantity of cooperated TRPs is reported in the CSI part 1, and wherein a size of a bitmap in the first group is based at least in part on the total number of NZCs across the plurality of layers and the quantity of cooperated TRPs reported in the CSI part 1.

Aspect 15: A method of wireless communication performed by a network node, comprising: transmitting, to a user equipment (UE), one or more reference signals from multiple transmit receive points (TRPs) associated with the network node; and receiving, from the UE and based at least in part on the one or more reference signals, a coherent joint transmission (CJT) Type II channel state information (CSI) feedback report that indicates a non-zero coefficient (NZC) selection bitmap, an NZC selection bitmap size for a TRP of the multiple TRPs being based at least in part on a scaling factor configured via higher layer signaling and a set of parameters associated with the TRP.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive one or more reference signals from multiple transmit receive points (TRPs) associated with a network node; and
transmit, to the network node and based at least in part on the one or more reference signals, a coherent joint transmission (CJT) Type II channel state information (CSI) feedback report that indicates a non-zero coefficient (NZC) selection bitmap, an NZC selection bitmap size for a TRP of the multiple TRPs being based at least in part on a scaling factor configured via higher layer signaling and a set of parameters associated with the TRP.

2. The apparatus of claim 1, wherein the set of parameters includes:
a number of polarizations,
a rank indicator,
a number of spatial domain bases associated with the TRP, and
a number of frequency domain bases associated with the TRP.

3. The apparatus of claim 1, wherein the scaling factor is common for the multiple TRPs, and wherein the scaling factor is rank-pair specific.

4. The apparatus of claim 1, wherein the NZC selection bitmap size is not less than a maximum total number of NZCs across a plurality of layers per TRP.

5. The apparatus of claim 1, wherein the NZC selection bitmap is associated with an NZC selection, and wherein a quantity of coefficients associated with the TRP are sorted using a priority function for a single TRP prior to the NZC selection.

6. The apparatus of claim 5, wherein the quantity of coefficients is based at least in part on a number of polarizations, a rank indicator, a number of spatial domain bases associated with the TRP, and a number of frequency domain bases associated with the TRP.

7. The apparatus of claim 5, wherein a coefficient of the quantity of coefficients is associated with a layer index, a spatial domain (SD) basis index, and a permutated frequency domain (FD) basis index, and wherein a priority level for the quantity of coefficients is based at least in part on an order of layer, SD basis, and permutated FD basis.

8. The apparatus of claim 1, wherein the NZC selection bitmap is associated with an NZC selection of the TRP, wherein the NZC selection of the TRP is performed across high priority coefficients of the TRP, and wherein each bit in the NZC selection bitmap corresponds to one of the high priority coefficients.

9. (canceled)

10. (canceled)

11. The apparatus of claim 1, wherein the NZC selection bitmap is associated with the TRP and is partitioned to form a first group and a second group, and wherein the first group includes a quantity of highest priority bits in the NZC selection bitmap and a quantity of highest priority NZCs, and wherein the second group includes a remaining quantity of lowest priority bits in the NZC selection bitmap and a quantity of lowest priority NZCs.

12. (canceled)

13. (canceled)

14. (canceled)

15. An apparatus for wireless communication at a network node, comprising:
a memory; and
one or more processors, coupled to the memory, configured to:
transmit, to a user equipment (UE), one or more reference signals from multiple transmit receive points (TRPs) associated with the network node; and
receive, from the UE and based at least in part on the one or more reference signals, a coherent joint transmission (CJT) Type II channel state information (CSI) feedback report that indicates a non-zero coefficient (NZC) selection bitmap, an NZC selection bitmap size for a TRP of the multiple TRPs being based at least in part on a scaling factor configured via higher layer signaling and a set of parameters associated with the TRP.

16. A method of wireless communication performed by a user equipment (UE), comprising:
receiving one or more reference signals from multiple transmit receive points (TRPs) associated with a network node; and
transmitting, to the network node and based at least in part on the one or more reference signals, a coherent joint transmission (CJT) Type II channel state information (CSI) feedback report that indicates a non-zero coefficient (NZC) selection bitmap, an NZC selection bitmap size for a TRP of the multiple TRPs being based at least in part on a scaling factor configured via higher layer signaling and a set of parameters associated with the TRP.

17. The method of claim 16, wherein the set of parameters includes:
a number of polarizations,
a rank indicator,
a number of spatial domain bases associated with the TRP, and
a number of frequency domain bases associated with the TRP.

18. The method of claim 16, wherein the scaling factor is common for the multiple TRPs, and wherein the scaling factor is rank-pair specific.

19. The method of claim 16, wherein the NZC selection bitmap size is not less than a maximum total number of NZCs across a plurality of layers per TRP.

20. The method of claim 16, wherein the NZC selection bitmap is associated with an NZC selection, and wherein a quantity of coefficients associated with the TRP are sorted using a priority function for a single TRP prior to the NZC selection.

21. (canceled)

22. (canceled)

23. The method of claim 16, wherein the NZC selection bitmap is associated with an NZC selection of the TRP, wherein the NZC selection of the TRP is performed across high priority coefficients of the TRP, and wherein each bit in the NZC selection bitmap corresponds to one of the high priority coefficients.

24. (canceled)

25. (canceled)

26. The method of claim 16, wherein the NZC selection bitmap is associated with the TRP and is partitioned to form a first group and a second group, and the first group includes a quantity of highest priority bits in the NZC selection bitmap and a quantity of highest priority NZCs, and wherein the second group includes a remaining quantity of lowest priority bits in the NZC selection bitmap and a quantity of lowest priority NZCs.

27. The method of claim 26, wherein the NZC selection bitmap is partitioned to maintain a non-zero precoding matrix indicator based at least in part on the second group being omitted due to insufficient uplink shared channel resources for CJT Type II CSI feedback reporting.

28. The method of claim 26, wherein a number of NZCs across a plurality of layers per TRP is reported in a CSI part 1, and wherein a size of a bitmap in the first group is based at least in part on the number of NZCs across the plurality of layers per TRP reported in the CSI part 1.

29. The method of claim 26, wherein a number of NZCs across a plurality of layers per TRP is not reported in a CSI part 1, wherein a total number of NZCs across the plurality of layers and a quantity of cooperated TRPs is reported in the CSI part 1, and wherein a size of a bitmap in the first group is based at least in part on the total number of NZCs across the plurality of layers and the quantity of cooperated TRPs reported in the CSI part 1.

30. (canceled)
